(19) United States
(12) Patent Application Publication
(10) Pub. No.: US 2014/0292279 A1
(43) Pub. Date: Oct. 2, 2014

(54) SYSTEM AND METHOD FOR EXTENDING USEFUL LIFE OF LITHIUM-ION AND BATTERIES OF SIMILAR TYPE

(71) Applicant: NVIDIA CORPORATION, Santa Clara, CA (US)

(72) Inventor: William E Rehbock, Santa Clara, CA (US)

(73) Assignee: Nvidia Corporation, Santa Clara, CA (US)

(21) Appl. No.: 13/852,441

(22) Filed: Mar. 28, 2013

(51) Int. Cl. H02J 7/00

(52) U.S. Cl. CPC H02J 7/00
USPC 320/134

(57) ABSTRACT

A system for, and method of, extending useful life of a battery and a battery-powered device incorporating the system or the method. In one embodiment, the system includes: (1) a charge detector operable to detect a charge level contained in the battery, (2) a use modeler coupled to the charge detector and operable to receive data from the charge detector and develop a model of the charge level over time and (3) a charge activator coupled to the use modeler and operable to forego an opportunity to charge the battery when a sufficient charge remains in the battery to last until a full charge can likely be undertaken.

### TECHNICAL FIELD

This application is directed, in general, to battery charging circuits and, more specifically, to a smart battery charging circuit for lithium-ion or similar-type batteries.

### BACKGROUND

The technique used to charge a battery should be tailored to the chemistry of the battery being charged. For example, lead-acid batteries have a relatively high tolerance for overcharging and exhibit the longest useful life when maintained at or near a full charge. Accordingly, lead-acid batteries may be charged by connecting them to a simple charger, which provides a constant voltage or constant current source. The constant voltage or current may be pulsed or steady. Trickle chargers provide a small but constant charge over a long period of time to “float” the battery at or near a full charge. Timer-based chargers or car alternators provide a moderate charge over a long but finite period of time, e.g., one to several hours. High-rate chargers provide a significant charge over minutes, but generally require the battery be monitored to guard against overcharging.

Rechargeable alkaline and nickel metal-hydride batteries, such as Ni—Cd batteries, offer higher power densities than, but can be charged in much the same way as, lead-acid batteries. However, rechargeable alkaline batteries require a pulsed source. The temperature of nickel metal-hydride batteries can and should be monitored during charging as an indication of their charge and to ensure they do not overcharge and overheat. Further, nickel metal-hydride batteries are subject to “memory effect,” in which they gradually lose their maximum energy capacity if they are repeatedly recharged after being only partially discharged.

Lithium-ion, or Li-ion, batteries are even more power-dense than nickel metal-hydride batteries and are widely used in consumer electronics (such as tablets, cellphones and MP3 players), tools, electric vehicles as well as medical, military and aerospace applications. The most popular chemistry is lithium cobalt oxide (LiCoO₂). Similar chemistries, including lithium iron phosphate (LFP), lithium nickel manganese cobalt oxide (NMC), lithium manganese oxide (LMO) and lithium titanate (LTO), tend to be used in more sensitive or exotic applications.

While extraordinarily powerful, lithium-ion batteries have two considerable drawbacks. First, they can only be recharged a limited number of times (typically about 500 to 1000 times), which limits their useful life. Second, they are subject to a destructive and potentially dangerous phenomenon called thermal runaway, which occurs if they are overcharged. Accordingly, lithium-ion batteries are carefully charged in three stages. The first stage is a constant current stage in which a constant current source is connected to the battery until a per-cell maximum voltage is reached. The second stage is a balance stage in which the level of the constant current is reduced and a balancing circuit is employed to balance the charge among the cells that constitute the battery. The third stage is a constant voltage stage in which a constant voltage source is connected to the battery, the voltage of the constant voltage source equaling the per-cell maximum voltage multiplied by the number of cells in the battery.

It is apparent that nickel metal-hydride and lithium-ion batteries require some finesse in charging. Accordingly, so-called “smart” battery chargers (defined as being capable of responding to the condition of a battery by modifying its charging actions) have been developed to charge them safely and carefully such that their useful lives are as long as reasonably possible. Smart battery charges mitigate memory effect in nickel metal-hydride batteries by occasionally deep-discharging them and guard against thermal runaway in lithium-ion batteries by carefully monitoring their temperature and limiting their charge current and voltage. Smart battery chargers are in wide use today and expected to remain in place as long as batteries benefiting from them are used.

### SUMMARY

One aspect provides a system for extending useful life of a battery and a battery-powered device incorporating the system or the method. In one embodiment, the system includes: (1) a charge detector operable to detect a charge level contained in the battery, (2) a use modeler coupled to the charge detector and operable to receive data from the charge detector and develop a model of the charge level over time and (3) a charge activator coupled to the use modeler and operable to forego an opportunity to charge the battery when a sufficient charge remains in the battery to last until a full charge can likely be undertaken.

Another aspect provides a method of extending useful life of a battery. In one embodiment, the method includes: (1) monitoring a charge level of the battery, (2) employing the battery charge level monitored over time to develop a battery use model, (3) detecting an opportunity to charge the battery and (4) employing the current battery charge level and the battery use model to determine a likelihood of the battery retaining at least some charge until a likely next full charge.

Yet another aspect provides a battery-powered device. In one embodiment, the device includes: (1) a load, (2) a lithium-ion battery, (3) a charge detector operable to detect a charge level contained in the battery, (4) a use modeler coupled to the charge detector and operable to receive data from the charge detector and develop a model of the charge level over time and (5) a charge activator coupled to the use modeler and operable to forego an opportunity to charge the battery when a sufficient charge remains in the battery to last until a full charge can likely be undertaken and take the opportunity when the battery is unlikely to retain at least some charge until the full charge can likely be undertaken.

### BRIEF DESCRIPTION

Reference is now made to the following descriptions taken in conjunction with the accompanying drawings, in which:

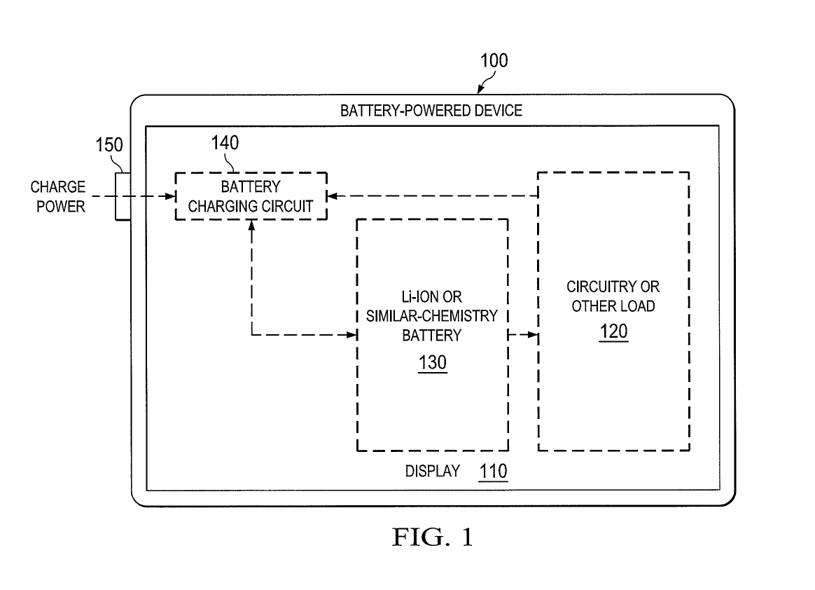

FIG. 1 is a high-level diagram of a battery-powered device containing a battery charging circuit including a system for extending useful life of a lithium-ion battery or a battery of similar type;

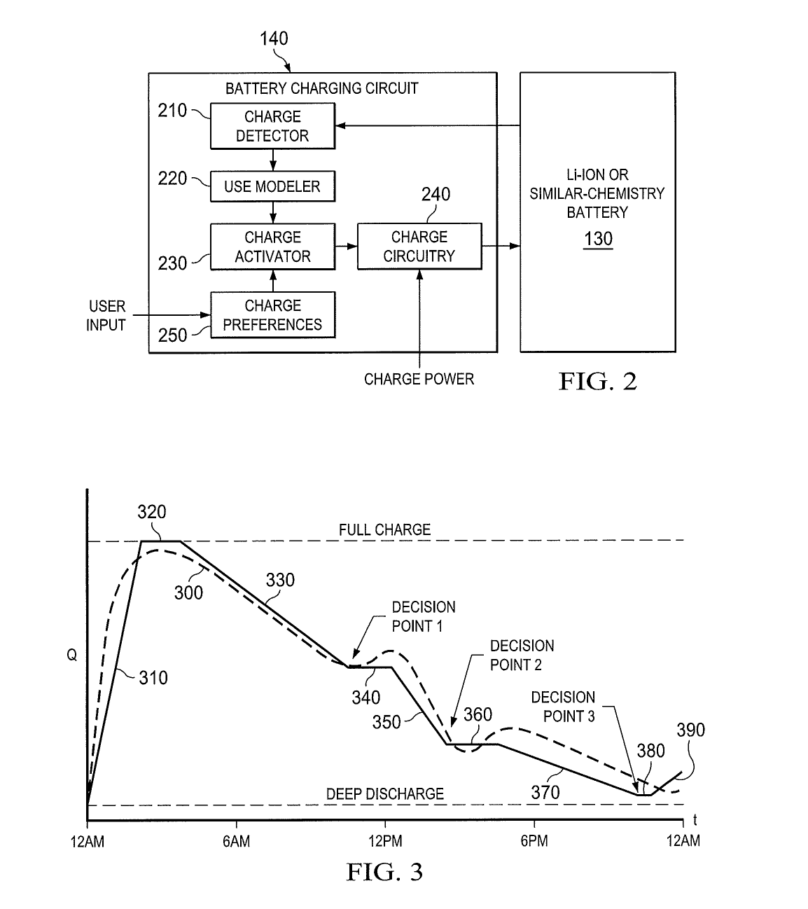

FIG. 2 is a block diagram of one embodiment of a system for extending useful life of a lithium-ion battery or a battery of similar type;

FIG. 3 is a graph of an example of a use model and battery use for a particular example day; and

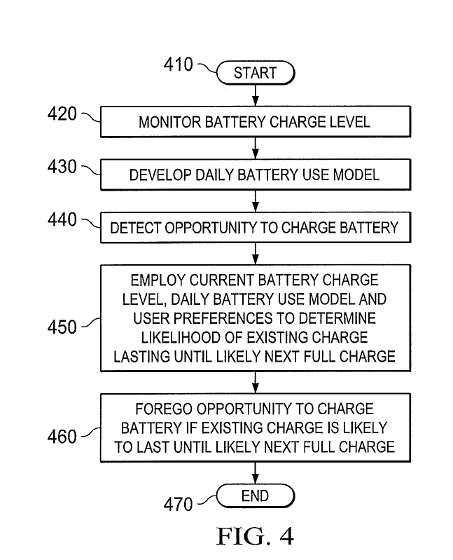

FIG. 4 is a flow diagram of one embodiment of a system for extending useful life of a lithium-ion battery or a battery of similar type.

### DETAILED DESCRIPTION

Lithium-ion batteries belong to a family of similar chemistries, namely rechargeable batteries in which ions of Group 1 alkali metals ions (usually the more reactive metals, including lithium, sodium and potassium) move from the negative electrode to the positive electrode when discharging, and from the positive electrode back to the negative electrode when charging. Lithium-ion batteries also belong to a family of similar type, in that they are limited in terms of the number of times they can be recharged. It is realized herein that the battery type to which lithium-ion batteries belong should be regarded as having a “cost” associated with recharging them; each recharge depreciates their value and shortens their useful life.

Conventional charging circuits in battery-powered devices (such as tablets, phones, MP3 players, tools and instruments) recharge their lithium-ion (or similar) batteries at a typical fast-charge rate, then shut down to prevent damaging overcharging. However, when batteries are left charging for extended periods of time, conventional charging circuits subject the batteries to repeated charge and discharge cycles without the device even being used. This represents an especially wasteful depletion of the number of useable charge cycles. Complicating this issue is that more modern charging circuits are embedded in larger systems and thus may be invoked unintentionally. As just one example, automobiles may include a cradle for mounting a cellphone, a GPS unit or an MP3 player so it can be used while driving. Unfortunately, such cradles typically also provide a battery-charging function. Thus, a device left cradled may not only perform useful and desired functions, but also be charging its battery inadvertently. This problem is likely to become more widespread when high-power USB becomes available, and battery charging is integrated with USB.

As stated in the Background above, lithium-ion batteries can only be recharged a limited number of times (typically about 500 to 1000 times), which limits their useful life. It is realized herein that while taking care in the charging of a battery certainly helps to extend its useful life, some potential exists to reduce the frequency at which a battery is charged. Stated another way, it is realized herein that reducing the frequency at which a battery is charged reduces the “cost” incurred over time with recharging.

More specifically, it is realized herein that an opportunity exists to forego unnecessary charge cycles altogether. It is further realized that a historical battery use pattern may be employed to make a future battery use prediction. It is yet further realized herein that, a future battery use prediction, together with a knowledge of the current level of charge a battery contains, can provide sufficient information to determine the likelihood that the charge will suffice until a full charge can be undertaken.

It is still further realized herein that the full charge is most likely to occur when the user is asleep and not using the device in question. For many but not all users, this would be at night. It is realized herein that the time that a full charge should take place can be part of the future battery use prediction.

Accordingly, introduced herein are various embodiments of a system and method for extending the useful life of lithium-ion and batteries of similar type. In certain embodiments, the system and method employ battery use history to predict future use, which allows them intentionally to forego opportunities to charge a battery when those opportunities are likely to be unnecessary. In other embodiments, the system and method employ battery use history to predict a suitable time in the future at which a battery can be charged fully.

FIG. 1 is a high-level diagram of a battery-powered device 100 containing a battery charging circuit 140 including a system for extending useful life of a lithium-ion battery or a battery of similar type. The battery-powered device 100 may be a laptop computer a tablet computer, a cellphone, a smartphone, a portable digital assistant (PDA), a Global Positioning Satellite (GPS) unit or any device having a display 110. The battery-powered device may alternatively be a radio or walkie-talkie, a CD or MP3 audio player, a DVD video player, a camera such as a digital camera, a remote control, a battery-powered hand tool, a flashlight, a toy or an instrument such as a musical or scientific instrument. The battery-powered device 100 may be any other conventional or later-developed device as well.

The battery-powered device 100 contains electronic circuitry, electrical circuitry or another type of load 120. The circuitry or other load 130 typically performs the useful functions for which the device exists and may include, for example, an integrated circuit (IC), memory, wireless or wireline communication circuitry, a keypad, a motor, switches, sensors and an antenna. The battery-powered device 100 also contains a lithium-ion battery or a battery 130 of similar chemistry, type or both chemistry and type coupled to the circuitry or other load 120 such that the battery 130 can provide power to the circuitry or other load 120.

The battery charging circuit 140 is coupled to the battery 130 to allow the battery charging circuit 140 to charge the battery 130. The battery charging circuit 140 employs external power to perform the charging function. In the illustrated embodiment, the external power is received through a cord, connector or port 150.

The battery charging circuit 140 may receive input from, or be controlled by, the circuitry or other load 120. In one embodiment, the novel system disclosed herein is part of the battery charging circuit 140. In an alternative embodiment, the novel system is part of the circuitry or other load 120. In yet another embodiment, the novel system is part of both the battery charging circuit 140 and the circuitry or other load 120, or other portions of the battery-powered device. For example, the novel system may be part of a dedicated battery charger into which a battery-powered devices is plugged.

FIG. 2 is a block diagram of one embodiment of a system for extending useful life of a lithium-ion battery or a battery of similar type. In the embodiment of FIG. 2, the system is part of the battery charging circuit 140 of FIG. 1.

A charge detector 210 is operable to detect a charge level contained in the battery 130. In the illustrated embodiment, the charge detector 210 is operable to ascertain the charge level by monitoring current flowing into and out of the battery 130, a technique known as coulomb counting. Those skilled in the pertinent art are aware of various conventional ways to determine or estimate the charge level a battery has. All such ways fall within the broad scope of the invention.

A use modeler 220 is coupled to the charge detector 210. In the illustrated embodiment, the use modeler 220 is operable to receive data from the charge detector 210 and develop a model of the charge level of the battery over time, e.g., a day. The model may take the form of a curve representing charge level as a function of time averaged over a window of days.

A charge activator 230 is coupled to the use modeler 220. In the illustrated embodiment, the charge activator 230 is operable to activate charge circuitry 240 to cause the battery 130 to be charged when appropriate. In the illustrated embodiment, the charge activator 230 is operable to determine, at certain decision points, whether or not a charge should be undertaken. In the illustrated embodiment, the decision points occur when a battery-powered device is coupled to charge power (e.g., when the device is plugged in to a source of power or placed in the cradle of a charger) or shortly thereafter. Thus, in the illustrated embodiment, each decision point occurs when the opportunity to charge arises. The question involves whether or not to take advantage of the opportunity, bearing in mind that it has both a possible benefit and a certain cost.

In the illustrated embodiment, the charge activator 230 is operable to employ the use model to determine whether sufficient charge level remains in the battery to last until a full charge can likely be undertaken, e.g., at night, when the user is likely asleep. In one embodiment, the charge activator 230 takes stored charge preferences 250 resulting from user input into account. In the illustrated embodiment, the charge preferences 250 determine the level of risk the user is prepared to accept that the battery device will not have a sufficient charge to last until the full charge can be undertaken.

To understand how the use modeler 220 and charge activator 230 may operate, reference will now be made to FIG. 3, which is a graph of an example of a use model and battery use for a particular example day. Accordingly, the x axis is time, t, and the y axis is battery charge level, Q. t is shown as including approximately 24 hours, and Q is shown as encompassing a range between no charge and a full charge. Unreferenced horizontal broken lines illustrate full charge and a deep discharge levels, the latter typically being advantageous to avoid.

Having made charge level measurements or estimations over a window of, e.g., a few weeks, the use modeler 220 of FIG. 2 is operable to average samples of determined or estimated charge level to produce a use model, the use model taking the form of a curve 300 shown in broken line in FIG. 2. The use model indicates a full charge usually takes place overnight, starting about 12 AM and lasting a couple of hours. Thereafter a series of discharges and charges takes place until about 12 AM, at which time another full charge begins to takes place.

The battery-relevant events of the particular example day are also shown in FIG. 3. The day begins with the battery-powered device coupled to charge power, allowing a full charge to take place during a first segment 310. During a second segment 320, the battery-powered device sits idly. During a third segment 330, the battery-powered device is removed from the charge power and used, causing its battery to discharge gradually. During a fourth segment 340, the battery-powered device is again coupled to charge power. This causes a decision point, one designated in FIG. 3 as Decision Point 1, to be encountered. At Decision Point 1, a decision needs to be reached as to whether or not to undertake a charge of the battery. Accordingly, the use model is employed, which indicates that, while further discharge is likely, it is unlikely to exceed the charge remaining in the battery. More specifically, it is unlikely to result in a deep discharge of the battery. Accordingly, a decision is reached to forego a charge, resulting in a lack of charging that the horizontality of the fourth segment 340 signifies.

During a fifth segment 350, the battery-powered device is again removed from the charge power and used, causing its battery to discharge at a slightly greater rate than in the third segment 330. During a sixth segment 360, the battery-powered device is yet again coupled to charge power. This causes another decision point, one designated in FIG. 3 as Decision Point 2, to be encountered. At Decision Point 2, a decision needs to be reached as to whether or not to undertake a charge of the battery. Accordingly, the use model is again employed, which indicates that, while further discharge is yet likely, it is still unlikely to exceed the charge remaining in the battery. More specifically, it remains unlikely to result in a deep discharge of the battery. Accordingly, a decision is again reached to forego a charge, resulting in a lack of charging that the horizontality of the sixth segment 360 signifies.

During a seventh segment 370, the battery-powered device is again removed from the charge power and used, causing its battery to discharge at a slightly lower rate than in the third segment 330. During an eighth segment 380, the battery-powered device is yet again coupled to charge power. This causes another decision point, one designated in FIG. 3 as Decision Point 3, to be encountered. At Decision Point 3, a decision needs to be reached as to whether or not to undertake a charge of the battery. Accordingly, the use model is yet again employed. However, this time the model indicates not only that is further discharge unlikely, but also that the battery-powered device is likely to remain coupled to charge power for quite some time and that the full charge can thus likely be undertaken. Accordingly, a decision is reached to allow a charge to take place, resulting in the beginning of a charge that a segment 390 signifies.

One will note that the terms “likely” and “unlikely” are used several times in the above example. As stated in conjunction with FIG. 2, charge preferences are employed in various embodiments to determine the level of risk the user is prepared to accept, i.e. the likelihood, that the battery-powered device will not have sufficient charge to last until the full charge can be undertaken. If the user is risk-averse, the charge preferences may require a relatively high likelihood, e.g., 99%. If the user is prepared to accept significant risk, the charge preferences may require a much lower likelihood, e.g., 70%. Those skilled in the pertinent art will understand that charge preferences may take many forms and remain fully within the broad scope of the invention.

FIG. 4 is a flow diagram of one embodiment of a system for extending useful life of a lithium-ion battery or a battery of similar type. The method begins in a start step 410. In a step 420, the battery charge level is monitored. In a step 430, the battery charge level monitored over time is employed to develop a battery use model. In a step 440, an opportunity to charge the battery is detected. In a step 450, the current battery charge level, the daily battery use model and the charge preferences are employed to determine the likelihood of the existing charge lasting until the likely next full charge. In a step 460, the opportunity to charge the battery is foregone if the existing charge is likely to last until the likely next full charge. Otherwise, if the existing charge is unlikely to last until the likely next full charge, the opportunity to charge the battery is taken. The method ends in an end step 470.

It should be stated that in no case will the battery-powered device be subject to more charge cycles than conventional charging methods inflict, and further that the battery-powered device is highly likely to experience more useful charge cycles over the life of the battery.

Those skilled in the art to which this application relates will appreciate that other and further additions, deletions, substitutions and modifications may be made to the described embodiments.

What is claimed is:

1. A system for extending useful life of a battery, comprising:
a charge detector operable to detect a charge level contained in said battery;
a use modeler coupled to said charge detector and operable to receive data from said charge detector and develop a model of said charge level over time; and
a charge activator coupled to said use modeler and operable to forego an opportunity to charge said battery when a sufficient charge remains in said battery to last until a full charge can likely be undertaken.

2. The system as recited in claim 1 wherein said charge detector is operable to ascertain said charge level by monitoring current flowing into and out of said battery.

3. The system as recited in claim 1 wherein said detector is operable to detect said charge level over at least a day.

4. The system as recited in claim 1 wherein said use model represents charge level as a function of time averaged over a window of days.

5. The system as recited in claim 1 wherein said full charge occurs at night.

6. The system as recited in claim 1 wherein said charge activator is configured to forego said opportunity based on charge preferences resulting from user input.

7. The system as recited in claim 6 wherein said charge preferences determine a level of risk a user is prepared to accept that said battery will not have a sufficient charge to last until said full charge can be undertaken.

8. A method of extending useful life of a battery, comprising:
monitoring a charge level of said battery;
employing said battery charge level monitored over time to develop a battery use model;
detecting an opportunity to charge said battery; and
employing said current battery charge level and said battery use model to determine a likelihood of said battery retaining at least some charge until a likely next full charge.

9. The method as recited in claim 8 further comprising foregoing said opportunity if said battery is likely to retain at least some charge until a likely next full charge.

10. The method as recited in claim 8 further comprising taking said opportunity if said battery is unlikely to retain at least some charge until a likely next full charge.

11. The method as recited in claim 8 further comprising further employing charge preferences to determine said likelihood.

12. The method as recited in claim 8 wherein said at least some charge exceeds a deep discharge level of said battery.

13. The method as recited in claim 8 further comprising activating charge circuitry based on said employing said current battery charge level and said battery use model.

14. The method as recited in claim 8 wherein said battery is a lithium-ion battery.

15. A battery-powered device, comprising:
a load;
a lithium-ion battery;
a charge detector operable to detect a charge level contained in said battery;
a use modeler coupled to said charge detector and operable to receive data from said charge detector and develop a model of said charge level over time; and
a charge activator coupled to said use modeler and operable to forego an opportunity to charge said battery when a sufficient charge remains in said battery to last until a full charge can likely be undertaken and take said opportunity when said battery is unlikely to retain at least some charge until said full charge can likely be undertaken.

16. The device as recited in claim 15 wherein said charge detector is operable to ascertain said charge level by monitoring current flowing into and out of said battery.

17. The device as recited in claim 15 wherein said detector is operable to detect said charge level over at least a day.

18. The device as recited in claim 15 wherein said use model represents charge level as a function of time averaged over a window of days.

19. The device as recited in claim 15 wherein said charge activator causes said full charge to occur at night.

20. The device as recited in claim 15 wherein said charge activator is configured to forego said opportunity based on charge preferences reflecting a level of risk a user is prepared to accept that said battery will not have a sufficient charge to last until said full charge can likely be undertaken.
